(19) United States
(12) Patent Application Publication
(10) Pub. No.: US 2023/0133177 A1
(43) Pub. Date: May 4, 2023

(54) DISPERSING AND GRINDING DEVICE

(71) Applicant: ASHIZAWA FINETECH LTD., Narashino-shi, Chiba (JP)

(72) Inventors: Tsuyoshi ISHIKAWA, Narashino-shi (JP); Yasuhiro MITSUHASHI, Narashino-shi (JP); Tomonobu FUNAYAMA, Narashino-shi (JP)

(73) Assignee: ASHIZAWA FINETECH LTD., Narashino-shi, Chiba (JP)

(21) Appl. No.: 17/914,135

(22) PCT Filed: Jun. 16, 2021
(86) PCT No.: PCT/JP2021/022809

§ 371 Date: Sep. 23, 2022

(30) Foreign Application Priority Data
Mar. 9, 2021 (JP) 2021-037324

(51) Int. Cl. B02C 7/06; B02C 23/36; B01F 23/53; B01F 27/71; B01F 27/271; B01F 33/80; B01F 23/50

(52) U.S. Cl. CPC B02C 7/06; B02C 23/36; B01F 23/53; B01F 27/71; B01F 27/271; B01F 33/83613; B01F 23/59; B01F 33/821

(57) ABSTRACT

A dispersing and grinding device for dispersing or grinding particles in a particle-containing liquid with a shear force generated when the particle-containing liquid passes through a gap, the dispersing and grinding device including: a casing; a rotor, a stator, and an impeller; and drive means. The gap is defined between the stator and the rotor. When the rotor and the impeller are rotated by the drive means, the particle-containing liquid is allowed to flow into the casing through an inflow portion of the casing by a rotating force of the impeller, and passes through the gap to cause the particles in the particle-containing liquid to be dispersed or ground with a shear force generated when the particle-containing liquid passes through the gap.

### TECHNICAL FIELD

The present invention relates to a device (hereinafter referred to as “dispersing and grinding device”) for dispersing or grinding particles contained in a liquid (hereinafter referred to as “particle-containing liquid”), and more particularly, to a medialess dispersing and grinding device which does not involve use of media such as beads.

### BACKGROUND ART

Hitherto, as a medialess dispersing and grinding device that disperses or grinds particles contained in a particle-containing liquid, there has been known a dispersing and grinding device (Patent Literature 1) which has been filed by the applicant of the subject application prior to filing of the subject application. This dispersing and grinding device is configured to disperse or grind particles contained in a particle-containing liquid with a shear force generated when the particle-containing liquid passes through a gap defined between a casing and a rotor.

The above-mentioned dispersing and grinding device can disperse or grind particles on a micro scale without causing contamination, which may occur when use of media is involved.

### CITATION LIST

### Patent Literature

[PTL 1] JP 6799865 B2

### SUMMARY OF INVENTION

### Technical Problem

In order to disperse or grind the particles in the particle-containing liquid into finer particles, a shear rate (shear velocity) is required to be increased. The dispersing and grinding device described in Patent Literature 1 achieves an increase in shear rate through high-speed rotation of a rotor (rotating body). When the rotor is rotated at high speed, however, the particle-containing liquid may generate heat, leading to material degradation due to the heat. Further, large energy is required to rotate the rotor at high speed. There is a limit even when the rotor is rotated at high speed, and thus it is difficult to obtain fine particles of a size that is only achievable with use of a dispersing and grinding device that involves use of media.

The present invention has been made in view of the circumstances described above, and has an object to provide a dispersing and grinding device that is capable of increasing a shear rate with energy smaller than energy required by a related-art medialess dispersing and grinding device, and thus dispersing or grinding particles into particles finer than particles obtained by the related-art medialess dispersing and grinding device.

### Solution to Problem

According to the present invention, there is provided a dispersing and grinding device for dispersing or grinding particles in a particle-containing liquid with a shear force generated when the particle-containing liquid passes through a gap, the dispersing and grinding device including: a casing having an inflow portion configured to allow the particle-containing liquid to flow into the casing and an outflow portion configured to allow the particle-containing liquid to flow out of the casing; a rotor, a stator, and an impeller (rotating body with vanes) that are arranged inside the casing; and drive means for rotating the rotor and the impeller. The gap is defined between the stator and the rotor. When the rotor and the impeller are rotated by the drive means, the particle-containing liquid is allowed to flow into the casing through the inflow portion by a rotating force of the impeller, and passes through the gap to cause the particles in the particle-containing liquid to be dispersed or ground with a shear force generated when the particle-containing liquid passes through the gap.

### Advantageous Effects of Invention

The dispersing and grinding device according to the present invention can increase the shear rate with energy smaller than that required by a related-art medialess dispersing and grinding device owing to an action of the impeller provided in the casing, and thus can disperse or grind the particles contained in the particle-containing liquid into particles finer than those obtained by the related-art medialess dispersing and grinding device.

### BRIEF DESCRIPTION OF DRAWINGS

FIG. 1 is a schematic explanatory view of a circulation treatment system in which a dispersing and grinding device according to the present invention is installed.

FIG. 2 is a sectional view for illustrating an internal structure of the dispersing and grinding device according to the present invention.

FIG. 3 is a sectional view for illustrating the internal structure of the dispersing and grinding device according to the present invention.

### DESCRIPTION OF EMBODIMENTS

### Embodiment

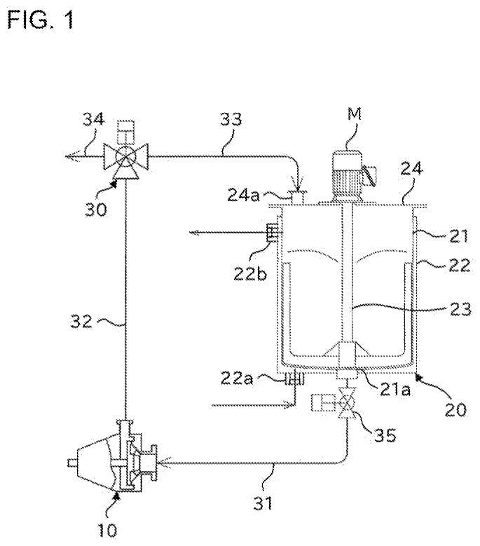

An example of a dispersing and grinding device 10 according to an embodiment of the present invention is described with reference to the drawings. The dispersing and grinding device 10 of this embodiment is installed and used in a treatment system as illustrated in FIG. 1. Examples of the treatment system include a circulation treatment system and a pass treatment system. In this embodiment, there is described as an example a case in which the dispersing and grinding device 10 is installed in a circulation treatment system.

As an example, the treatment system illustrated in FIG. 1 includes a particle-containing liquid tank 20, the dispersing and grinding device 10, and a three-way valve 30. The particle-containing liquid tank 20 is configured to store a particle-containing liquid (slurry) being a target to be treated. The dispersing and grinding device 10 is configured to disperse or grind particles contained in the particle-containing liquid supplied from the particle-containing liquid tank 20. The three-way valve 30 is configured to change a flow passage for the particle-containing liquid which has passed through the dispersing and grinding device 10.

The particle-containing liquid tank 20 and the dispersing and grinding device 10 are connected to each other through a first flow passage 31. The dispersing and grinding device 10 and the three-way valve 30 are connected to each other through a second flow passage 32. The three-way valve 30 and the particle-containing liquid tank 20 are connected to each other through a third flow passage 33. A valve 35 configured to open and close the first flow passage 31 is provided in the first flow passage 31. For example, an existing automatic valve may be used as the valve 35.

The particle-containing liquid tank 20 is a container configured to store the particle-containing liquid being the target to be treated. In this embodiment, a jacket tank is used as the particle-containing liquid tank 20. The jacket tank includes a stirring vessel 21 and a jacket 22 mounted onto an outer periphery of the stirring vessel 21. Other containers may be used as the particle-containing liquid tank 20.

The stirring vessel 21 is a container configured to store the particle-containing liquid and allow the particle-containing liquid to be stirred therein. The stirring vessel 21 of this embodiment has a bottomed cylindrical shape with an upper opening. A stirring-vessel discharge port 21a that allows the particle-containing liquid in the stirring vessel 21 to be discharged to an outside is formed in a bottom surface of the stirring vessel 21. The upper opening of the stirring vessel 21 can be opened and closed by a lid 24.

A stirring rod 23 with vanes that is configured to stir the particle-containing liquid in the stirring vessel 21 is provided inside the stirring vessel 21. The stirring rod 23 is rotated by a stirring motor M that is placed on the lid 24 configured to open and close the upper opening of the stirring vessel 21. The lid 24 has a feedback port 24a to which an outlet side of the third flow passage 33 is connected. The particle-containing liquid which has passed through the third flow passage 33 is fed back into the stirring vessel 21 through the feedback port 24a.

The jacket 22 is configured to allow circulation of cooling water for cooling the particle-containing liquid stored in the stirring vessel 21. A cooling-water introduction port 22a that allows the cooling water to be introduced into the jacket 22 is formed in a bottom surface of the jacket 22. A cooling-water discharge port 22b that allows the cooling water to be discharged to an outside of the jacket 22 is formed in a side surface of the jacket 22. Although not shown, a chiller (cooling-water circulating device) including a cooling-water introduction passage and a cooling-water discharge passage is connected to the cooling-water introduction port 22a and the cooling-water discharge port 22b. This structure allows the cooling water supplied from the chiller to circulate inside the jacket 22.

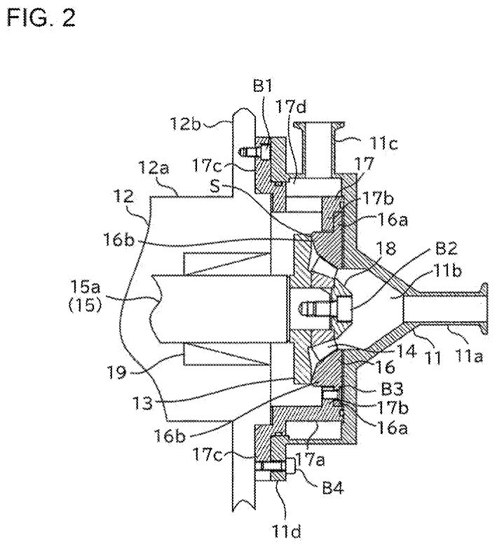

The dispersing and grinding device 10 is configured to disperse or grind particles contained in the particle-containing liquid with a shear force generated when the particle-containing liquid passes through a gap S (FIG. 2). The term “disperse” means that powder is separated as fine as possible into single particles and the particles are distributed into a fluid or other components in a uniform manner or while forming a structure. The term “grind” means an operation of pulverizing a material into powder.

As illustrated in FIG. 2, the dispersing and grinding device 10 according to this embodiment includes a casing 11, a housing 12, a rotor 13, an impeller 14, drive means 15, a stator 16, and an intermediate member 17.

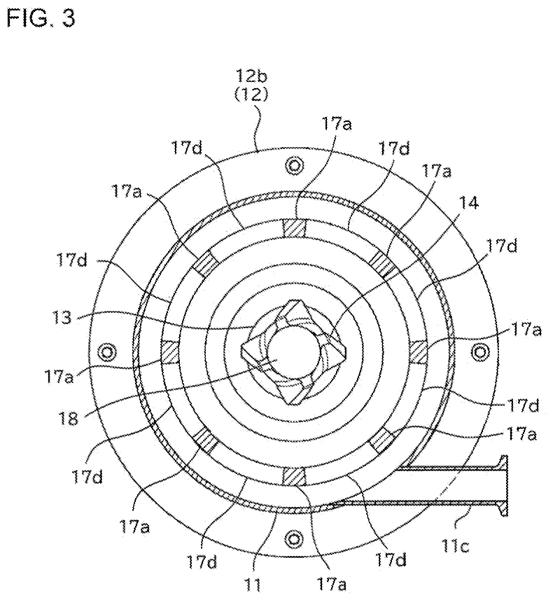

The casing 11 is a case configured to receive the particle-containing liquid stored in the particle-containing liquid tank 20 inside. The particles contained in the particle-containing liquid, which has been introduced into the casing 11, are dispersed or ground inside the casing 11. The casing 11 of this embodiment has an inflow portion 11a having a tubular shape, an accommodating portion 11b having a hollow conical shape (trumpet-like shape), and an outflow portion 11c having a tubular shape. The particle-containing liquid flows into the casing 11 through the inflow portion 11a. Components such as the rotor 13 and the impeller 14 are accommodated in the accommodating portion 11b. The particle-containing liquid flows out of the casing 11 through the outflow portion 11c. As illustrated in FIG. 3, the outflow portion 11c is formed to extend in a tangential direction to the casing 11.

The inflow portion 11a, the accommodating portion 11b, and the outflow portion 11c of the casing 11 communicate with each other inside the casing 11. This structure allows the particle-containing liquid, which has flowed into the casing 11 through the inflow portion 11a, to pass through the accommodating portion 11b and flow to an outside of the casing 11 through the outflow portion 11c. The casing 11 includes a larger-end side flange 11d projecting outward that is formed at a larger end of the casing 11 (end of the casing 11 on a side opposite to the inflow portion 11a).

The housing 12 is a case in which the drive means 15 is accommodated. The housing 12 of this embodiment includes a body portion 12a and a brim-shaped portion 12b having a disc-like shape. The drive means 15 is accommodated in the body portion 12a. The brim-shaped portion 12b projects outward from an end of the body portion 12a. An outwardly projecting portion 17c of the intermediate member 17 described later is brought into contact with the brim-shaped portion 12b, and the outwardly projecting portion 17c and the brim-shaped portion 12b are fixed together with use of a first fixture B1.

The rotor 13 is a disc-shaped member having a diameter smaller than a diameter of the brim-shaped portion 12b of the housing 12. The rotor 13 is provided on a distal end side of a rotary shaft 15a of the drive means 15. A mixed flow impeller (mixed flow pump) is provided as the impeller 14 on a front surface (on the inflow portion 11a side) of the rotor 13. The mixed flow impeller allows a generated flow to move within a conical surface having a center line of its main shaft as an axis.

The mixed flow impeller has a large flow rate, and thus can increase pressure. Thus, the particle-containing liquid is forced to pass through the gap S at high speed and high pressure. When the flow rate is increased with use of the mixed flow impeller, the particle-containing liquid passes faster to enable suppression of heat generation. Further, when the flow rate is increased with use of the mixed flow impeller, the effects of increasing the number of passages of the circulating particle-containing liquid are achieved to thereby more easily provide homogenous products.

A retainer 18 configured to retain the rotor 13 and the impeller 14 is arranged on a distal end side of the impeller 14. The retainer 18 is fixed to a distal end of the rotary shaft 15a together with the rotor 13 and the impeller 14 with use of a second fixture B2. The impeller 14 is rotated together with the rotor 13 and the retainer 18 in the same direction as a rotating direction of the rotary shaft 15a through rotation of the rotary shaft 15a of the drive means 15 described later.

The drive means 15 is means for rotating the rotor 13 and the impeller 14. The drive means 15 of this embodiment includes a motor (not shown) and the rotary shaft 15a coupled to the motor. A mechanical seal 19 configured to prevent outflow of the particle-containing liquid is provided at an outer periphery of the rotary shaft 15a.

The stator 16 is a member configured to create a flow of the particle-containing liquid in cooperation with the rotor 13 and the impeller 14. The stator 16 of this embodiment is a disc-shaped member having an opening formed in a center, which allows accommodation of the impeller 14. The stator 16 includes a flange portion 16a projecting outward. The flange portion 16a is brought into contact with the intermediate member 17 described later, and the flange portion 16a and the intermediate member 17 are fixed together with use of a third fixture B3.

A protrusion 16b having an annular shape is formed on a surface of the stator 16, which is on a side closer to the rotor 13, so as to be opposed to the rotor 13. The extremely small gap S through which the particle-containing liquid passes is defined between the protrusion 16b and the rotor 13. A dimension of the gap S may be set to 100 μm or smaller, preferably, 70 μm or smaller, more preferably, 30 μm or smaller.

Although not shown, a groove including a protrusion and a recess may be formed on a surface (surface opposed to the rotor 13) of the stator 16, which defines the gap S. The groove formed on the surface of the stator 16 enables dispersion or grinding of the particles contained in the particle-containing liquid to finer particles. The groove including a protrusion and a recess may be formed to extend in a direction parallel to a direction of passage of the particle-containing liquid or in a direction intersecting with the direction of passage of the particle-containing liquid.

The intermediate member 17 is a member arranged between the casing 11 and the stator 16. The intermediate member 17 of this embodiment includes a cylindrical portion 17a, an inwardly projecting portion 17b, and the outwardly projecting portion 17c. The cylindrical portion 17a is formed at such a position as to cover outsides of the stator 16, the rotor 13 and the impeller 14. The inwardly projecting portion 17b is formed on one end side of the cylindrical portion 17a so as to project inward therefrom. The outwardly projecting portion 17c is formed on another end side of the cylindrical portion 17a so as to project outward therefrom.

The flange portion 16a of the stator 16 is brought into contact with the inwardly projecting portion 17b of the intermediate member 17, and the flange portion 16a and the inwardly projecting portion 17b are fixed together with use of the third fixture B3. The larger-end side flange 11d of the casing 11 is brought into contact with the outwardly projecting portion 17c of the intermediate member 17, and the larger-end side flange 11d and the outwardly projecting portion 17c are fixed together with use of a fourth fixture B4.

In this embodiment, a shim (spacer), which is not shown, can be inserted into a space between the flange portion 16a of the stator 16 and the inwardly projecting portion 17b of the intermediate member 17. The gap S between the rotor 13 and the protrusion 16b can be adjusted by inserting the shim into the space.

The cylindrical portion 17a of the intermediate member 17 has a plurality of openings 17d formed at intervals in a circumferential direction of the cylindrical portion 17a. The openings 17d are formed at such positions as to enable the gap S between the rotor 13 and the stator 16 to be viewed from the outside. After the shim is inserted into the space between the flange portion 16a of the stator 16 and the inwardly projecting portion 17b of the intermediate member 17, it can be checked through the openings 17d whether the gap S having a suitable width has been defined between the rotor 13 and the stator 16.

The number and a size of the openings 17d may be suitably set. The opening 17d is required to have equal to or larger than a width (for example, a length of about 20 mm by a width of about 20 mm) checkable with use of a clearance gauge. The openings 17d also serve as passages for the particle-containing liquid. Thus, it is preferred that the openings 17d be as wide as possible. In any case, it is preferred that the openings 17d be formed at such positions as to enable the gap S between the rotor 13 and the stator 16 to be viewed. The openings 17d are only required to be formed as needed.

In the treatment system described in this embodiment, the particle-containing liquid stored in the particle-containing liquid tank 20 flows into the dispersing and grinding device 10 through the first flow passage 31. When the treatment system performs a circulating operation, the particle-containing liquid which has passed through the dispersing and grinding device 10 passes through the second flow passage 32, the three-way valve 30, and the third flow passage 33 in the stated order, and then is fed back into the particle-containing liquid tank 20. When the particle-containing liquid is discharged, the particle-containing liquid passes through the second flow passage 32 and the three-way valve 30 to be discharged into a fourth flow passage 34.

### Operation

Now, an operation of the dispersing and grinding device 10 of this embodiment in the treatment system is described. The rotary shaft 15a is rotated by the motor of the drive means 15. Then, when the rotor 13 and the impeller 14, which are coupled to the rotary shaft 15a, are rotated, the particle-containing liquid flows into the casing 11 through the inflow portion 11a. The particle-containing liquid which has flowed into the casing 11 moves into the accommodating portion 11b, and then passes through the extremely small gap S along a flow passage defined by the impeller 14. The particles in the particle-containing liquid are dispersed or ground with a shear force generated when the particle-containing liquid passes through the gap S. The particle-containing liquid which has passed through the gap S flows to the outside through the outflow portion 11c.

The dispersing and grinding device 10 of this embodiment is installed in the circulation treatment system. Thus, the particle-containing liquid which has flowed out through the outflow portion 11c passes through the second flow passage 32 and the three-way valve 30, and then is returned back to the particle-containing liquid tank 20 (stirring vessel 21) through the third flow passage 33. After that, the treatment in the dispersing and grinding device 10 is repeated for a predetermined number of times to disperse or grind the particles into particles of a desired size.

The dispersing and grinding device 10 of this embodiment not only has the smaller gap S but also is configured to force the particle-containing liquid to pass through the gap S at high speed and high pressure owing to a pumping action of the mixed flow impeller. Thus, even though the dispersing and grinding device 10 is of a medialess type, the dispersing and grinding device 10 is expected to achieve a shear rate equal to or larger than a shear rate obtained by the dispersing and grinding device that involves use of media. Thus, the particles in the particle-containing liquid can be dispersed or ground into particles of a size (nano order) substantially equal to a size of particles obtained by the dispersing and grinding device that involves use of media.

For example, when the gap S is set to 30 μm, and a peripheral speed of the rotor 13 is set to 30 m/sec, the dispersing and grinding device 10 according to the present invention is expected to achieve a shear rate of about 1 million/sec, which corresponds to a shear rate of a high-pressure homogenizer. In addition, heat generation, which may be caused by high-speed rotation, is expected to be minimized.

### Other Embodiments

The dispersing and grinding device according to the present invention is not limited to that described above in the embodiment. Changes such as addition or elimination of a configuration or interchange of configurations are possible without changing the gist of the invention.

The dispersing and grinding device 10 installed in the circulation treatment system has been described as an example in the embodiment. However, the dispersing and grinding device 10 according to the present invention may also be installed in a pass treatment system.

The use of the mixed flow impeller as the impeller 14 has been described as an example in the embodiment. However, an impeller other than the mixed flow impeller, for example, an axial flow impeller (axial flow pump) that feeds a particle-containing liquid in an axial direction may also be used as the impeller 14.

The dispersing and grinding device 10 laid with its axial direction aligned with a horizontal direction when in use has been described as an example in the embodiment. However, the dispersing and grinding device 10 according to the present invention may be laid with its axial direction aligned with a vertical direction when in use.

### INDUSTRIAL APPLICABILITY

The dispersing and grinding device 10 according to the present invention may be used for dispersion or grinding particles contained in various kinds of particle-containing liquids used for, for example, battery materials, cosmetic products, food, electronic components, and paint.

### REFERENCE SIGNS LIST

10 dispersing and grinding device
11 casing
11a inflow portion
11b accommodating portion
11c outflow portion
11d larger-end side flange
12 housing
12a body portion
12b brim-shaped portion
13 rotor
14 impeller
15 drive means
15a rotary shaft
16 stator
16a flange portion
16b protrusion
17 intermediate member
17a cylindrical portion
17b inwardly projecting portion
17c outwardly projecting portion
17d opening
18 retainer
19 mechanical seal
20 particle-containing liquid tank
21 stirring vessel
21a stirring-vessel discharge port
22 jacket
22a cooling-water introduction port
22b cooling-water discharge port
23 stirring rod
24 lid
24a feedback port
30 three-way valve
31 first flow passage
32 second flow passage
33 third flow passage
34 fourth flow passage
35 valve
B1 first fixture
B2 second fixture
B3 third fixture
B4 fourth fixture
M stirring motor
S gap

1. A dispersing and grinding device for dispersing or grinding particles in a particle-containing liquid with a shear force generated when the particle-containing liquid passes through a gap, the dispersing and grinding device comprising:
a casing having an inflow portion configured to allow the particle-containing liquid to flow into the casing and an outflow portion configured to allow the particle-containing liquid to flow out of the casing;
a rotor, a stator, and an impeller that are arranged inside the casing; and
drive means for rotating the rotor and the impeller,
wherein the gap is defined between the stator and the rotor, and
wherein, when the rotor and the impeller are rotated by the drive means, the particle-containing liquid is allowed to flow into the casing through the inflow portion by a rotating force of the impeller, and passes through the gap to cause the particles in the particle-containing liquid to be dispersed or ground with a shear force generated when the particle-containing liquid passes through the gap.

2. The dispersing and grinding device according to claim 1, wherein the impeller comprises a mixed flow impeller.

3. The dispersing and grinding device according to claim 1, further comprising an intermediate member arranged on an outer side of both of the rotor and the stator,
wherein the intermediate member has openings configured to enable the gap between the rotor and the stator to be viewed from an outside.

4. The dispersing and grinding device according to claim 1, wherein the outflow portion is formed to extend in a tangential direction to the casing.
